(19) United States
(12) Patent Application Publication
(10) Pub. No.: US 2013/0297949 A1
(43) Pub. Date: Nov. 7, 2013

(54) HYBRID BLADE WEBSERVER WITH SOLAR AS PRIMARY POWER SOURCE

(71) Applicant: Jack J. Sun, Palo Alto, CA (US)

(72) Inventor: Jack J. Sun, Palo Alto, CA (US)

(21) Appl. No.: 13/462,821

(22) Filed: May 3, 2012

(51) Int. Cl. G06F 1/26

(52) U.S. Cl. CPC G06F 1/26
USPC 713/300

(57) ABSTRACT

An apparatus and method for green hybrid blade webserver that directly uses solar PV as primary power source at ultimate efficiency, with grid utility power (wall power) as backup source, is disclosed. In one embodiment, the invention can be retrofitted or mounted easily into a data center rack, plug in solar lines from PV panel on roof and run.

### FIELD OF THE INVENTION

This invention relates to the design of the green hybrid blade webserver (h-Blade) that takes solar PV power directly at ultimate efficiency. The present invention relates particularly to the methods that a standard rack mount blade computer server utilize the solar PV as primary energy source, with traditional grid power as backup source, and provide seamless web and data service operation.

### BACKGROUND OF THE INVENTION

From this inventor, patent application Ser. Nos. 13/372,479 and 13/436,663 described methods at data center level and power supply level for directly utilizing solar PV electricity at ultimate efficiency.

Based on further test and research on the operation, quick new technology adoption and maintenance easiness in an enterprise data center, or cloud computing facility; as well as cost, reliability and size (space) concerns, it's natural and very useful to invent an integrated and power-intelligent hybrid blade computer server. Such server system are widely used for web and data services.

### SUMMARY OF THE INVENTION

This invention presents the method and apparatus for the hybrid blade Server that directly uses solar power as primary source and backup by grid source.

### BRIEF DESCRIPTION OF THE DRAWINGS

FIG. 1 illustrates the function of a typical blade computer server

FIG. 2 shows the function of hybrid blade server (h-Blade) of the Invention, built on top of the green PSU described in patent application Ser. No. 13/436,663.

FIG. 3 shows the software control logic that track and manage the power source and consumption which is embedded in this invention.

### DETAILED DESCRIPTION OF THE DRAWINGS

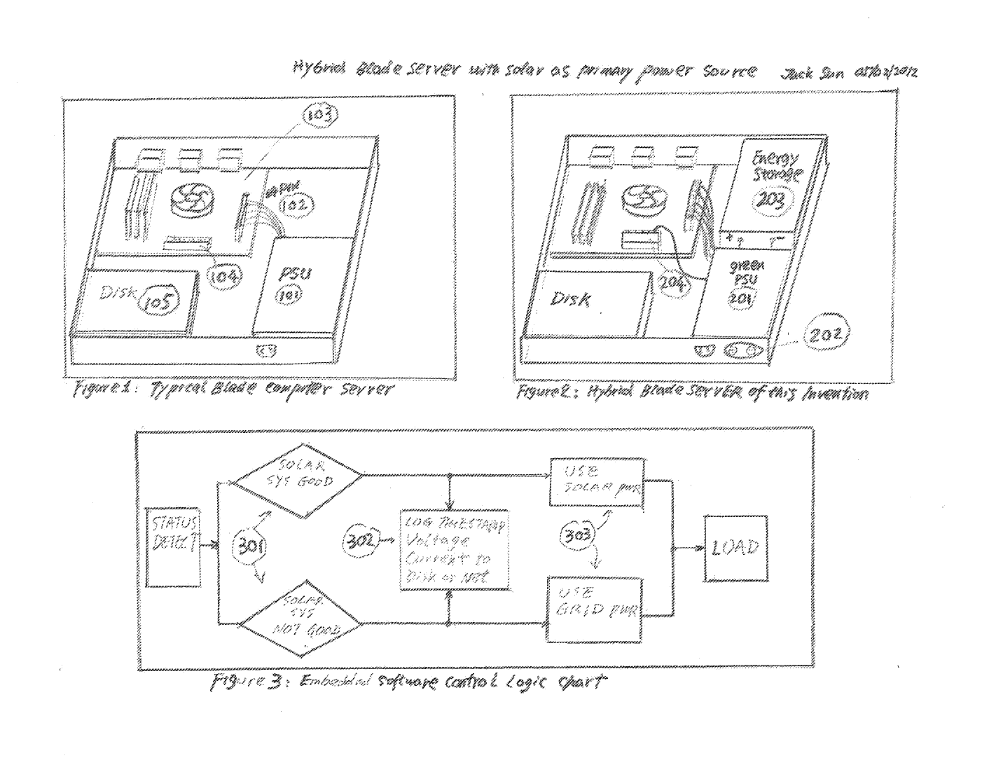

FIG. 1 shows a current typical traditional blade server hardware. The dimension of such rack mountable computer is usually 19″×1.75″×18″ (W×H×D). 101 is Traditional Power Supply Unit (PSU), with typical dimension of 3″×1.57″×10″, that takes grid wall power of 110V or 220V AC and converted it into 12V and lower DC for computing devices such as mother board 103, and disk drive 105, via standard 24P in connector 102. Notice there are usually reserved extra device connection slots 104 for customized or extended applications.

FIG. 2 shows the hybrid blade server (h-Blade) of this invention. 201 is the green Power Supply Unit (gPSU as disclosed in this inventor's patent application Ser. No. 13/436,663) which take solar PV natural dynamitic electricity via plug 202, optimized and regulated into stable 12V and lower DC to support the computing devices; And take grid or wall power as backup source. Extra solar energy is controlled by gPSU and kept in Energy Storage 203, which is usually a battery of LiFePO4 type or Lithium Ion type, but not the Lead Acid type for safety and reliability. 204 is the smart power computing device of this invention, plugged into computers existing slots, which track and collect green power usage data to be analyzed and used by end user, or by computer operating system, or by other 3^{rd} party power management software. Detail logic about smart power function is shown in FIG. 3.

FIG. 3 shows software control logic embedded in this invention. 301 collect and check solar and battery status, and signaling the quality of green power; 302 will keep record of status change history with Time Stamp; Voltage, Current and power data into computer disk, wired or wireless networks; 303 is the smart control decision based on 301, to deliver smooth power to the load. Depends on geological location and weather conditions, In California Silicon Valley area where inventor is conducting prototyping and testing, it is estimated that there is less than 20% chance to use grid wall power.

What is claimed is:

1. A method comprising:
A hybrid blade computer server that directly uses solar PV output as the primary power source and grid utility power as backup source in a smart and seamless mode to enable computer server stable operations.
